(19) United States
(12) Patent Application Publication
(10) Pub. No.: US 2005/0259185 A1
(43) Pub. Date: Nov. 24, 2005

(54) Gamma correction apparatus and method capable of preventing noise boost-up

(76) Inventors: Moon-cheol Kim, Yongin-si (KR); Sang-jin Lee, Seoul (KR)

Correspondence Address: STANZIONE & KIM, LLP, 919 18TH STREET, N.W., SUITE 440, WASHINGTON, DC, 20006, US

(21) Appl. No.: 11/086,467

(22) Filed: Mar. 23, 2005

(30) Foreign Application Priority Data
May 21, 2004 (KR) 2004-36498

(51) Int. Cl. H04N 5/202

(52) U.S. Cl. 348/674

(57) ABSTRACT

A gamma correction apparatus and method capable of preventing noise boost-up. A signal extraction unit extracts high-frequency signals and low-frequency signals from an input image signal, a temporary weight value calculation unit calculates a predetermined temporary weight value based on the luminance level of the input image signal, a decision unit determines the high-frequency signals of the extracted high-frequency signals involved in a gamma correction based on the calculated temporary weight value, and a gamma correction unit applies the gamma correction to the extracted high-frequency signals and low-frequency signals involved in the gamma correction, so that the present invention can prevent a noise boost-up phenomenon occurring upon the gamma correction.

### CROSS-REFERENCE TO RELATED APPLICATIONS

This application claims benefit under 35 U.S.C. § 119 from Korean Patent Application No. 2004-36498 filed on May 21, 2004 with the Korean Intellectual Property Office, the entire content of which is incorporated herein by reference.

### BACKGROUND OF THE INVENTION

1. Field of the Invention

The present general inventive concept relates to a gamma correction apparatus and method capable of preventing noise boost-up. More particularly, the present general inventive concept relates to a gamma correction apparatus and method capable of processing noise to prevent a noise boost-up phenomenon occurring upon gamma correction.

2. Description of the Related Art

In image-capturing devices such as camcorders, the luminance levels of output images to input voltages have the linear characteristics as shown in line (1) of FIG. 1, whereas the luminance levels of output images to input voltages in the cathode ray tubes (CRTs) have the nonlinear characteristics as shown in line (2) of FIG. 1. Such nonlinear characteristics cause distorted images on the CRT.

Accordingly, in order to correct or compensate such an image distortion, the gamma correction is applied to an image signal shown in line (1) of FIG. 1 to produce an image signal shown in line (3) of FIG. 1 as an input to the CRT. Hence, the CRT substantially displays images having the linear characteristics shown in line (1) of FIG. 1. That is, the gamma correction increases the luminance levels of input images according to line (3) of FIG. 1 so that the CRT has output images having the linear characteristics shown in line (1) of FIG. 1.

However, the conventional gamma correction increases the luminance levels of images together with the level of noise luminance, which causes a noise boost-up phenomenon, so there exists a problem of lowering a signal-to-noise ratio in the range of low-luminance levels of images displayed on the CRT.

Such a phenomenon can appear not only on a gamma correction device but also on a device having a nonlinear transfer function which relatively boosts up the low-luminance level.

### SUMMARY OF THE INVENTION

The present general inventive concept has been developed in order to solve the above drawbacks and other problems associated with the conventional arrangement. Accordingly, the present general inventive concept provides a gamma correction apparatus and method capable of processing noise to prevent a noise boost-up phenomenon upon gamma correction.

Additional aspects and advantages of the present general inventive concept will be set forth in part in the description which follows and, in part, will be obvious from the description, or may be learned by practice of the general inventive concept.

The foregoing and other aspects and advantages of the present general inventive concept are substantially realized by providing a gamma correction apparatus capable of preventing noise boost-up, comprising a signal extraction unit to extract high-frequency signals higher than a predetermined frequency and low-frequency signals lower than the predetermined frequency from an input image signal, a temporary weight value calculation unit to calculate a predetermined temporary weight value based on the luminance level of the input image signal, a decision unit to determine high-frequency signals involved in a gamma correction of the extracted high-frequency signals based on the calculated temporary weight value, and a gamma correction unit to apply the gamma correction to the extracted high-frequency signals and low-frequency signals involved in the gamma correction.

The temporary weight value calculation unit calculates a temporary weight value to reduce a ratio of the extracted high-frequency signals involved in the gamma correction as the luminance level of the input image signal becomes lower.

Further, the temporary weight value calculation unit calculates the temporary weight value inversely proportional to the luminance level of the input image signal.

The temporary weight value calculation unit can calculate the temporary weight value based on an equation as provided below:

$$\begin{matrix}\begin{matrix}k = - a \cdot {V}_{lum} + 1 , & ( 0 \leq {V}_{lum} \leq \frac{1}{a} )\end{matrix} \\ \begin{matrix}k = 0 , & ( {V}_{lum} > \frac{1}{a} ) ;\end{matrix}\end{matrix}$$

wherein k indicates the temporary weight value, −a indicates a slope of the temporary weight value, a indicates an absolute value of the slope, and Vₗᵤₘ indicates the luminance level of the input image signal.

The gamma correction apparatus further comprises a slope calculation unit to calculate the absolute value of the slope based on the brightness of frames or fields including the input image signal, wherein the frames or the fields becomes brighter as the absolute value of the slope becomes smaller.

The decision unit can include a subtracter to subtract the temporary weight value smaller than ‘1’ from ‘1’ to calculate a final weight value to be applied to the extracted high-frequency signals, and a multiplier to multiply the final weight value and the extracted high-frequency signals to calculate high-frequency signals involved in the gamma correction.

The signal extraction unit includes a low-pass filter to extract the low-frequency signals from the input image signal, a delay unit to delay the input image signal by a phase of the extracted low-frequency signals; and a subtracter to subtract the extracted low-frequency signals from the delayed input image signal to extract the high-frequency signals.

The gamma correction apparatus further comprises an adder to add the high-frequency signals and low-frequency signal to which the gamma correction has been applied to calculate a finally compensated image signal.

The gamma correction apparatus further comprises a multiplier to multiply the temporary weight value and the extracted high-frequency signals to calculate high-frequency signals not to be involved in the gamma correction, wherein the adder adds the input image signal to which the gamma correction has been applied to the high-frequency signals not involved in the gamma correction to output the final image signal of which edge components are compensated.

The foregoing and other aspects and advantages of the present general inventive concept are also substantially realized by providing a gamma correction method capable of preventing noise boost-up, the method comprising operations of extracting high-frequency signals higher than a predetermined frequency and low-frequency signals lower than the predetermined frequency from an input image signal, calculating a predetermined temporary weight value based on the luminance level of the input image signal, determining high-frequency signals involved in a gamma correction of the extracted high-frequency signals based on the calculated temporary weight value, and applying the gamma correction to the extracted high-frequency signals and low-frequency signals involved in the gamma correction.

The temporary weight value calculation operation can calculate a temporary weight value to reduce a ratio of the extracted high-frequency signals involved in the gamma correction as the luminance level of the input image signal becomes lower.

The temporary weight value calculation operation calculates the temporary weight value inversely proportional to the luminance level of the input image signal.

The temporary weight value calculation step calculates the temporary weight value based on an equation as below:

$$\begin{matrix}\begin{matrix}k = - a \cdot {V}_{lum} + 1 , & ( 0 \leq {V}_{lum} \leq \frac{1}{a} )\end{matrix} \\ \begin{matrix}k = 0 , & ( {V}_{lum} > \frac{1}{a} ) ;\end{matrix}\end{matrix}$$

wherein k indicates the temporary weight value, −a indicates a slope of the temporary weight value, a indicates an absolute value of the slope, and Vₗᵤₘ indicates the luminance level of the input image signal.

The gamma correction method may further comprise a slope calculation operation to calculate the absolute value of the slope based on an average luminance value of frames including the input image signal before the temporary weight value calculation operation, wherein the frames or the fields becomes brighter as the absolute value of the slope becomes smaller.

The decision operation includes operations of subtracting the temporary weight value smaller than ‘1’ from ‘1’ to calculate a final weight value to be applied to the extracted high-frequency signals, and multiplying the final weight value and the extracted high-frequency signals to calculate high-frequency signals involved in the gamma correction.

The signal extraction operation may include operations of extracting the low-frequency signals from the input image signal, delaying the input image signal by a phase of the extracted low-frequency signals, and subtracting the extracted low-frequency signals from the delayed input image signal to extract the high-frequency signals.

The gamma correction method further comprises an operation of adding the high-frequency signals and low-frequency signal to which the gamma correction has been applied to calculate a finally compensated image signal.

The gamma correction method further comprises an operation of multiplying the temporary weight value and the extracted high-frequency signals to calculate edge components of the input image signal, wherein the addition operation adds the compensated input image signal and the edge components to output the final image signal of which edge components have been compensated.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a graph explaining a general gamma correction;

FIG. 2 is a block diagram illustrating a gamma correction apparatus capable of preventing noise boost-up, according to an embodiment of the present general inventive concept;

FIG. 3 is a graph illustrating the sensitivity of human eyes with respect to frequencies;

FIG. 4 is a graph of a ratio of input voltage to output image signal in the general gamma correction;

FIG. 5 is a graph illustrating the sensitivity of human eyes with respect to luminance levels of input image signals;

FIG. 6 is a view illustrating a temporary weight value to determine a final weight value of high-frequency components involved in the gamma correction of FIG. 2;

FIG. 7 is a flowchart explaining a gamma correction method used with the apparatus of FIG. 2 and capable of preventing noise boost-up;

FIG. 8 is a block diagram illustrating a gamma correction apparatus capable of preventing noise boost-up according to another embodiment of the present general inventive concept; and

FIG. 9 is a view illustrating a final weight value of high-frequency components involved in the gamma correction of FIG. 8.

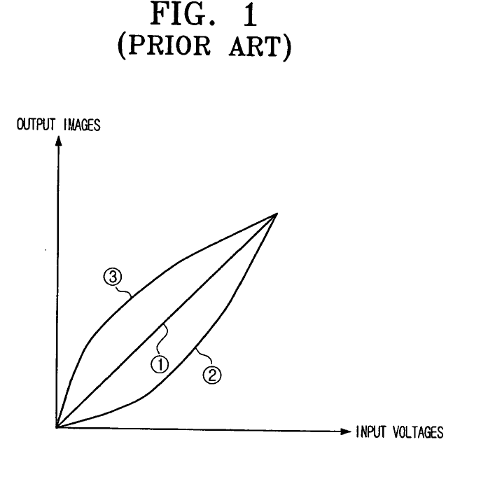

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

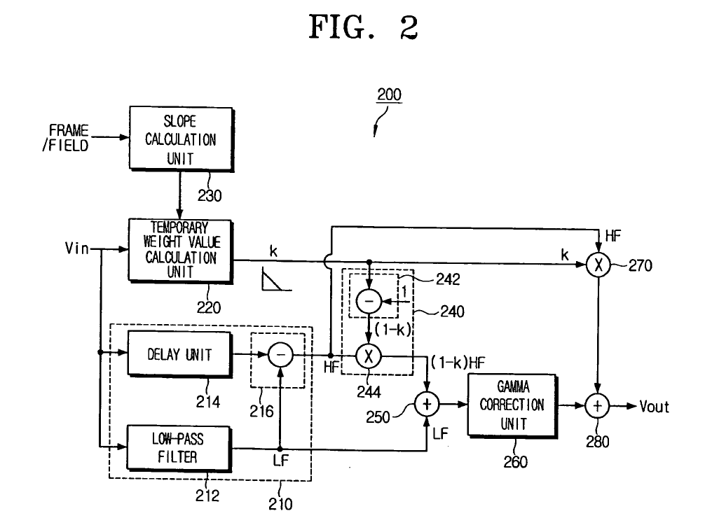

FIG. 2 is a block diagram illustrating a gamma correction apparatus capable of preventing noise boost-up according to an embodiment of the present general inventive concept.

In FIG. 2, the gamma correction apparatus 200 capable of preventing noise boost-up according to an embodiment of the present general inventive concept is an apparatus that prevents a noise boost-up phenomenon upon gamma correction.

The gamma correction apparatus 200 capable of preventing noise boost-up according the embodiment of FIG. 2 includes a signal extraction unit 210, a temporary weight value calculation unit 220, a slope calculation unit 230, a decision unit 240, a first adder 250, a gamma correction unit 260, a second multiplier 270, and a second adder 280.

The signal extraction unit 210 extracts low-frequency signals and high-frequency signals from an input image signal Vᵢₙ. To this end, the signal extraction unit 210 includes a low-pass filter 212, a delay unit 214, and a first subtracter 216.

The low-pass filter 212 extracts low-frequency signals (LF) from an input image signal Vᵢₙ, wherein the low-frequency signals are signals having frequencies lower than a predetermined frequency.

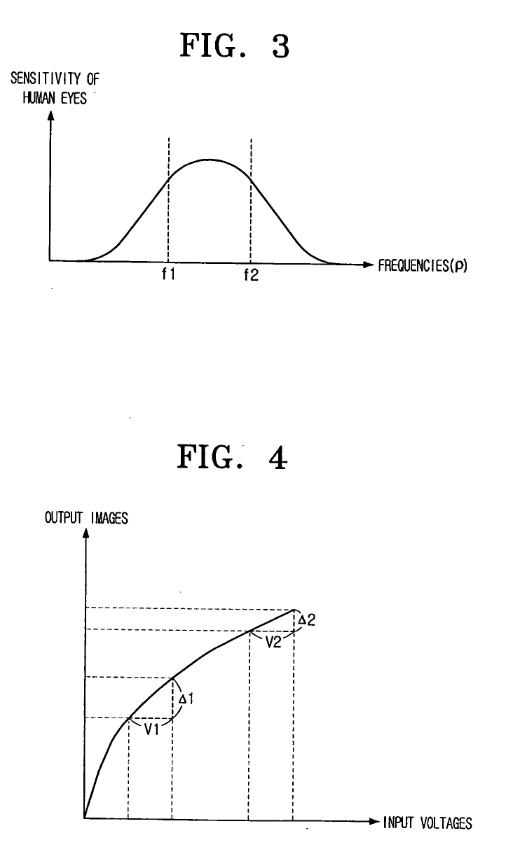

FIG. 3 is a graph illustrating the sensitivity of human eyes with respect to frequencies.

In FIG. 3, human eyes exhibit sensitive responses in the high-frequency range between frequencies f₁ and f₂. Thus, the human eyes more sensitively respond to noise in the high-frequency range f₁˜f₂ than noise in a low-frequency range (lower than the frequency f₁) of an image signal. Therefore, the low-pass filter 212 is set to the first frequency f₁ shown in FIG. 3 as a cutoff frequency to extract the low-frequency signals (LF).

The delay unit 214 delays the input image signal Vᵢₙ by a phase of the low-frequency signals (LF) extracted from the low-pass filter 212.

The first subtracter 216 subtracts the low-frequency signals (LF) from the delayed input image signal Vᵢₙ to extract high-frequency signals (HF).

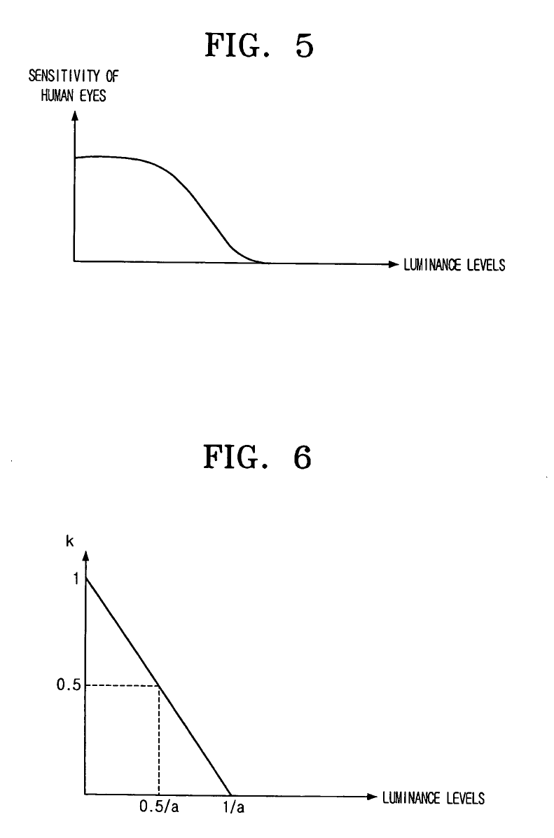

The temporary weight value calculation unit 220 calculates a variable k to determine a ratio (1−k) of the high-frequency signals of the extracted high-frequency signals (HF) involved in gamma correction. According to an embodiment of the present general inventive concept, the temporary weight value calculation unit 220 calculates the variable k by using the two characteristics to be described with reference to FIG. 4 and FIG. 5.

FIG. 4 is a graph illustrating a ratio of output image signals to input voltages in the general gamma correction, and FIG. 5 is a graph illustrating the sensitivity of human eyes with respect to the luminance levels of an input image signal.

As shown in FIG. 4, the first feature is that a variation amount (Δ1) of an output image signal corresponding to a range (v1) having a small input voltage is larger than a variation amount (Δ2) of an output image signal corresponding to a range (v2) having a large input voltage.

As shown in FIG. 5, the second feature is that human eyes exhibit more sensitive responses to the variations of the luminance levels as the luminance levels of an image signal become lower. For example, the human eyes show more sensitive responses when the luminance level of ‘0’ indicating the black color is changed to the luminance level of ‘1’ than when the luminance level of ‘255’ indicating the white color is changed to the luminance level of ‘244’.

That is, the above two features indicate that high-frequency noise is more relatively inserted into low-luminance levels than high-luminance levels and the human eyes show more sensitivity with respect to noise inserted in the low-luminance levels.

Accordingly, the temporary weight value calculation unit 220 calculates the variable k in order for the ratio (1−k) of the high-frequency signals (HF) involved upon gamma correction to become smaller as the luminance level of the input image signal Vᵢₙ becomes lower. Hereinafter, the ratio and variable of high-frequency signals involved in the gamma correction are referred to as a final weight value w and a temporary weight value k, respectively.

To do this, the temporary weight value calculation unit 220 calculates the temporary weight value k inversely proportional to the luminance level of the input image signal Vᵢₙ as shown in FIG. 6, which can be expressed in Equation 1 as provided below.

$$\begin{matrix}\begin{matrix}k = - a \cdot {V}_{lum} - 1 , & ( 0 \leq {V}_{lum} \leq \frac{1}{a} )\end{matrix} \\ \begin{matrix}k = 0 , & ( {V}_{lum} > \frac{1}{a} ) ;\end{matrix}\end{matrix} \qquad [ Equation 1 ]$$

wherein k indicates a temporary weight value to determine the final weight value w of high-frequency signals involved in gamma correction, −a indicates a slope of the temporary weight value, a indicates an absolute value of the slope, and Vₗᵤₘ indicates the luminance level of the input image signal Vᵢₙ normalized to ‘1’. The absolute value of the slope a is a threshold value determining whether to apply the k, and it is preferable that the value a becomes larger as overall images become darker. That is, the slope of the temporary weight value becomes greater as overall images become darker, so that the amount of noise inserted into the high-frequency signals (HF) can be reduced.

With reference to FIG. 6 and Equation 1, the temporary weight value calculation unit 220 calculates the k to ‘0’ (that is, k=0) if the luminance level of the input image signal Vᵢₙ is larger than 1/α. That is, the temporary weight value calculation unit 220 has all the high-frequency signals of the input image signal Vᵢₙ larger than the predetermined threshold value of 1/α in the gamma correction, and has only a unit of the high-frequency signals of the input image signal Vᵢₙ smaller than the predetermined threshold value of 1/α depending on the k.

For example, if a is set to 2 and an input image signal is an 8-bit image, the temporary weight value calculation unit 220 sets the k to ‘0’ (that is, k=0) with respect to an input image signal over the luminance level of ‘128’, and sets the k to ‘0.5’ (that is, k=0.5) with respect to an input image signal having the luminance level of ‘64’, since the luminance level of ‘128’ has a normalization value of ‘½’ and the luminance level of ‘64’ has a normalization value of ‘¼’. Therefore, the high-frequency components of the input image signal of the luminance level of ‘128’ are 100% involved in the gamma correction, and the high-frequency components of the input image signal of the luminance level of ‘64’ are 50% involved in the gamma correction.

On the other hand, the absolute value of a slope to calculate the temporary weight value k can be a specific value determined by statistical values of the image signal, or can vary depending on the characteristics of the current input image signal Vᵢₙ. In the later case, the absolute value a of the slope is calculated by the slope calculation unit 230.

The slope calculation unit 230 calculates the absolute value a of the slope based on the image information of one frame or field including the input image signal Vᵢₙ. For example, the slope calculation unit 230 calculates the absolute value a of the slope based on the brightness of a frame or field. The absolute value a of the slope becomes smaller as a frame or field becomes brighter.

The decision unit 240 determines the high-frequency signals of the high-frequency signals (HF) extracted by the signal extraction unit 210 to be involved in the gamma correction, based on the temporary weight value k calculated by the temporary weight value calculation unit 220.

To this end, the decision unit 240 has a second subtracter 242 and a first multiplier 244.

The second subtracter 242 subtracts from ‘1’ the temporary weight value k smaller than ‘1’ to calculate a final weight value (w=1−k) applied to the high-frequency signals (HF). The final weight value w becomes smaller as the temporary weight value k becomes larger, so the ratio of the high-frequency signals ((1−k)*HF) becomes smaller that is involved in the gamma correction.

The first multiplier 244 multiplies the final weight value w by the high-frequency signals (HF) to calculate the high-frequency signals ((1−k)*HF) to be involved in the gamma correction.

The first adder 250 adds a low-frequency signals (LF) extracted by the low-pass filter 212 and the high-frequency signals ((1−k)*HF) calculated by the first multiplier 244.

The gamma correction unit 260 applies the gamma correction to the low-frequency signals and high-frequency signals output from the first adder 250 for an output of an image signal (LF+((1−k)*HF)^{Y}) to which the gamma correction has been applied.

The second multiplier 270 multiplies the high-frequency signals (HF) and the temporary weight value k to calculate high-frequency signals (k*HF) not involved in the gamma correction, which is to compensate the edge components included in the high-frequency signals (HF).

The second adder 280 adds the high-frequency signals (k*HF) output from the second multiplier 270 and the image signal ((LF+1(1−k)*HF)^{Y}) output from the gamma correction unit 260 to which the gamma correction has been applied, so as to output a final image signal Vₒᵤₜ. The addition of the high-frequency signals (k*HF) not involved in the gamma correction compensates the edge components included in the high-frequency signals (HF) to create substantially the same image as an actual image. The final image signal (Vₒᵤₜ) to which the gamma correction has been applied can be expressed in Equation 2 as provided below.
Vₒᵤₜ=(LF+(1−k)*HF)^{γ}+k*HF [Equation 2]

In Equation 2, if the k is inversely proportional to the luminance level, the ratio w of the high-frequency signals involved in the gamma correction becomes smaller as images become darker. Thus, an amount of the increase of the noise level can be reduced.

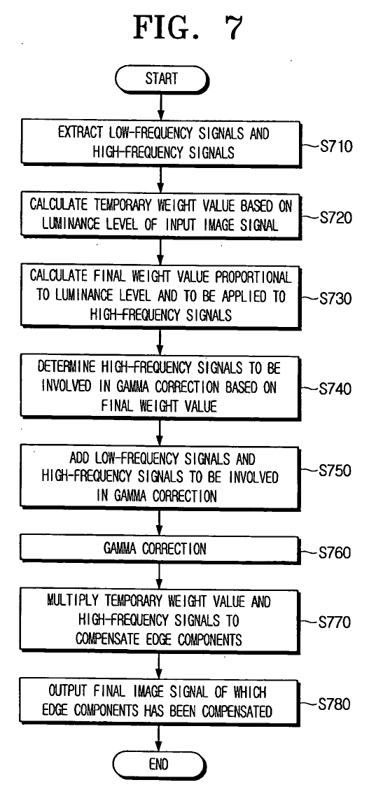

FIG. 7 is a flowchart explaining a gamma correction method used with the apparatus of FIG. 2 capable of preventing noise boost-up.

Referring to FIG. 2 through FIG. 7, the signal extraction unit 210 extracts the low-frequency signals LF and high-frequency signals HF from the input image signal Vᵢₙ operation (S710).

With the operation S710 executed, the temporary weight value calculation unit 220 calculates the temporary weight value k based on the luminance level of the input image signal Vᵢₙ (operation S720). The calculated temporary weight value k is inversely proportional to the magnitude of the luminance level.

The second subtracter 242 subtracts the temporary weight value k from ‘1’ to calculate the final weight value (1−k) (operation S730). The final weight value (1−k) is proportional to the low-luminance level. That is, the final weight value (1−k) reduces the ratio of high-frequency signals involved in the gamma correction as the luminance levels become lower.

The first multiplier 244 determines the high-frequency signals involved in the gamma correction based on the final weight value (1-k). That is, the first multiplier 244 multiplies the final weight value (1−k) and the high-frequency signals (HF) so that the high-frequency signals ((1−k)*HF) of the extracted high-frequency signals (HF) involved in the gamma correction are determined. Since the final weight value (1−k) given to the high-frequency signals becomes smaller as the luminance level becomes lower, the amount of the increase of the noise level can be reduced upon the gamma correction.

With the operation S740 executed, the first adder 250 adds the low-frequency signals (LF) and the high-frequency signals ((1−k)*HF) calculated by the first multiplier 244 (operation S750).

With the operation S750 executed, the gamma correction unit 260 applies the gamma correction to the low-frequency signals (LF) and the high-frequency signals ((1−k)*HF) that are output from the first adder 250 (operation S760).

With the operation S760 executed, the second multiplier 270 multiplies the high-frequency signals (HF) and the temporary weight value k to calculate the high-frequency signals (k*HF) not involved in the gamma correction (operation S770).

With the operation S770 executed, the second adder 280 adds an image signal ((LF+(1−k)*HF)^{Y}) output from the gamma correction unit 260 and to which the gamma correction has been applied and the high-frequency signals (k*HF) output from the second multiplier 270 to output a final image signal Vₒᵤₜ for which the edge components have been compensated.

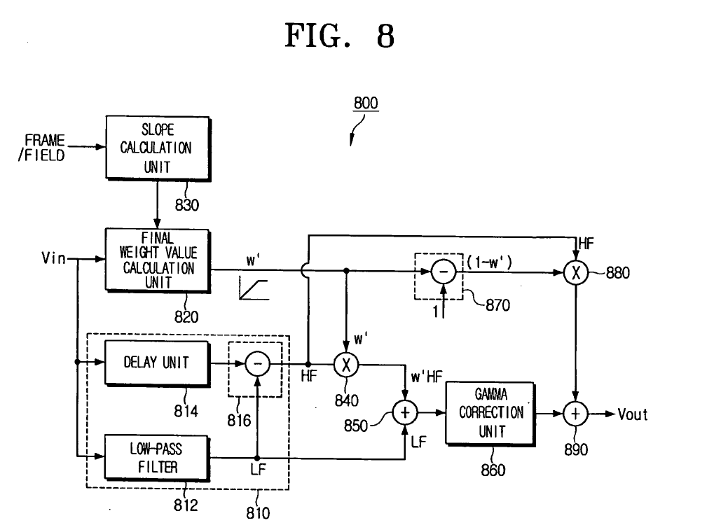

FIG. 8 is a block diagram illustrating a gamma correction apparatus capable of preventing noise boost-up according to another embodiment of the present general inventive concept.

In FIG. 8, the gamma correction apparatus 800 capable of preventing noise boost-up according to another embodiment of the present general inventive concept includes a signal extraction unit 810, a final weight value calculation unit 820, a slope calculation unit 830, a first multiplier 840, a first adder 850, a gamma correction unit 860, a second subtracter 870, a second multiplier 880, and a second adder 890.

Detailed descriptions of units and unit shown in FIG. 8 that have the functions similar to each unit shown in FIG. 2 will be skipped for conciseness.

The low-pass filter 812 extracts low-frequency signals (LF) of an input image signal Vᵢₙ. The delay unit 814 delays the input image signal Vᵢₙ by a phase of the low-frequency signals (LF) extracted from the low-pass filter 812.

The first subtracter 816 subtracts the low-frequency signals (LF) from the delayed input image signal Vᵢₙ to extract the high-frequency signals (HF). The final weight value calculation unit 820 calculates a ratio by use of the two described features with reference to FIG. 4 and FIG. 5.

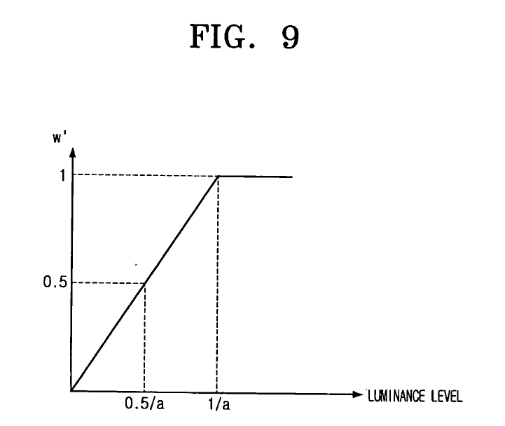

That is, as shown in FIG. 9, the final weight value calculation unit 820 reduces a ratio of the high-frequency signals (HF) involved in the gamma correction as the luminance level of the input image signal Vᵢₙ becomes lower. Hereinafter, the ratio of the high-frequency signals involved in the gamma correction is referred to as a final weight value w′, which can be expressed in Equation 3 as provided below:

$$\begin{matrix}\begin{matrix}{w}^{′} = {a}^{′} \cdot {V}_{lum} , & ( 0 \leq {V}_{lum} \leq \frac{1}{{a}^{′}} )\end{matrix} \\ \begin{matrix}{w}^{′} = 1 , & ( {V}_{lum} > \frac{1}{{a}^{′}} )\end{matrix}\end{matrix} \qquad [ Equation 3 ]$$

wherein, w′ has a final weight value of high-frequency signals involved in the gamma correction, a′ is a positive value as a slope of the final weight value, and Vₗᵤₘ is a luminance level of the input image signal Vᵢₙ normalized to ‘1’. The a′ expressed in a positive value is a threshold value determining whether to apply the w′, and the slope of the final weight value becomes less as the overall image becomes darker. Thus, as the overall image becomes darker, the amount of noise contained in the high-frequency signals (HF) can be reduced.

With reference to FIG. 9 and Equation 3, the final weight value calculation unit 820 sets the value of the w′ to ‘1’, that is, w′=1, if the luminance level of the input image signal Vᵢₙ is larger than 1/α′. That is, the final weight value calculation unit 820 has the high-frequency signals of the input image signal Vᵢₙ 100% involved in the gamma correction if the luminance level is larger than the predetermined threshold value of 1/α′, and has a unit of the high-frequency signals of the input image signal Vᵢₙ involved in the gamma correction depending on the w′ if the high-frequency signals are smaller than the predetermined threshold value of 1/α′.

The first multiplier 840 multiplies the final weight value w′ by the high-frequency signals (HF) extracted by the first subtracter 816 to calculate the high-frequency signals (w′*HF) involved in the gamma correction.

The first adder 850 adds the low-frequency signals (LF) extracted by the low-pass filter 812 and the high-frequency signals (w′*HF) calculated by the first multiplier 840.

The gamma correction unit 860 applies the gamma correction to the low-frequency signals and high-frequency signals output from the first adder 850 and outputs the image signal ((LF+w′*HF)^{Y}) to which the gamma correction has been applied.

The second subtracter 870 subtracts from ‘1’ the final weight value w′ smaller than ‘1’ to calculate the temporary weight value (1−w′) to be given to the high-frequency signals (HF).

The second multiplier 880 multiplies the temporary weight value (1−w′) and high-frequency signals (HF) output from the second subtracter 870 to calculate the high-frequency signals ((1−w′)*HF) not involved in the gamma correction.

The second adder 890 adds the image signal ((LF +w′ * HF)^{Y}) output from the gamma correction unit 860 and to which the gamma correction has been applied and the high-frequency signals ((1-w′)*HF) output from the second multiplier 880 to output the final image signal Vₒᵤₜ. The high-frequency signals ((1−w′)*HF) not being involved in the gamma correction are added to compensate the edge components contained in the high-frequency signals (HF). The final image signal Vₒᵤₜ to which the gamma correction has been applied can be expressed in Equation 4 provided below.
Vₒᵤₜ=(LF+w′*HF)^{γ}+(1−w′)*HF [equation 4]

With reference to FIG. 4, when the final weight value given to the high-frequency signals involved in the gamma correction is set to be proportional to the luminance level, the ratio of the high-frequency signals (HF) involved in the gamma correction is calculated low as the image becomes darker, so the amount of the increase of the noise level is reduced.

Therefore, with reference to FIG. 3 and FIG. 4, the present general inventive concept reduces the ratio of the high-frequency components involved in the gamma correction as the luminance level of the input image signal Vᵢₙ becomes lower by use of the two described features, so as to prevent noise boost-up.

On the other hand, a high-pass filter (not shown) can be provided rather than the delay unit 214 or 814 and the first subtracter 216 or 816 in the signal extraction unit 210 or 810 respectively. That is, it is possible to extract the high-frequency signals (HF) from the input image signal Vᵢₙ by use of the high-pass filter (not shown).

The above descriptions have been described with the gamma correction apparatus for cameras, as an example, for the sake of convenient explanations, but the present general inventive concept can be applied to an apparatus relatively boosting up the low-luminance level.

As described above, the gamma correction apparatus and method capable of preventing noise boost-up according to embodiments of the present general inventive concept prevent the noise boost-up phenomenon by lessening a ratio of the high-frequency components involved in the gamma correction as the luminance level of the input image signal Vᵢₙ becomes lower. Furthermore, the present general inventive concept compensates the edge components so that it can prevent artifacts occurring at edge portions, by which the CRT can display high-quality images.

The present general inventive concept does not need an extra matrix necessary to obtain a luminance signal so that the usage of hardware resources can be reduced and the competitiveness of products can be strengthened.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A gamma correction apparatus capable of preventing noise boost-up, comprising:
a signal extraction unit to extract high-frequency signals higher than a predetermined frequency and low-frequency signals lower than the predetermined frequency from an input image signal;
a temporary weight value calculation unit to calculate a predetermined temporary weight value based on the luminance level of the input image signal;
a decision unit to determine high-frequency signals involved in a gamma correction of the extracted high-frequency signals based on the calculated temporary weight value; and
a gamma correction unit to apply the gamma correction to the extracted high-frequency signals and low-frequency signals involved in the gamma correction.

2. The gamma correction apparatus as claimed in claim 1, wherein the temporary weight value calculation unit calculates a temporary weight value to reduce a ratio of the extracted high-frequency signals involved in the gamma correction as the luminance level of the input image signal becomes lower.

3. The gamma correction apparatus as claimed in claim 2, wherein the temporary weight value calculation unit calculates the temporary weight value inversely proportional to the luminance level of the input image signal.

4. The gamma correction apparatus as claimed in claim 3, wherein the temporary weight value calculation unit calculates the temporary weight value based on the following equation:
$$\begin{matrix}\begin{matrix}k = - a \cdot {V}_{lum} + 1 , & ( 0 \leq {V}_{lum} \leq \frac{1}{a} )\end{matrix} \\ \begin{matrix}k = 0 , & ( {V}_{lum} > \frac{1}{a} ) ;\end{matrix}\end{matrix}$$
wherein k indicates the temporary weight value, −a indicates a slope of the temporary weight value, a indicates an absolute value of the slope, and Vₗᵤₘ indicates the luminance level of the input image signal.

5. The gamma correction apparatus as claimed in claim 4, further comprising a slope calculation unit to calculate the absolute value of the slope based on the brightness of frames or fields including the input image signal,
wherein the frames or the fields becomes brighter as the absolute value of the slope becomes smaller.

6. The gamma correction apparatus as claimed in claim 3, wherein the decision unit comprises:
a subtracter to subtract the temporary weight value smaller than ‘1’ from ‘1’ to calculate a final weight value to be applied to the extracted high-frequency signals; and
a multiplier to multiply the final weight value and the extracted high-frequency signals to calculate high-frequency signals involved in the gamma correction.

7. The gamma correction apparatus as claimed in claim 1, wherein the signal extraction unit comprises:
a low-pass filter to extract the low-frequency signals from the input image signal;
a delay unit to delay the input image signal by a phase of the extracted low-frequency signals; and
a subtracter to subtract the extracted low-frequency signals from the delayed input image signal to extract the high-frequency signals.

8. The gamma correction apparatus as claimed in claim 1, further comprising an adder to add the high-frequency signals and low-frequency signal to which the gamma correction has been applied to calculate a finally compensated image signal.

9. The gamma correction apparatus as claimed in claim 8, further comprising a multiplier to multiply the temporary weight value and the extracted high-frequency signals to calculate high-frequency signals not to be involved in the gamma correction,
wherein the adder adds the input image signal to which the gamma correction is applied to the high-frequency signals not involved in the gamma correction to output the final image signal of which edge components are compensated.

10. A gamma correction method capable of preventing noise boost-up, comprising operations of:
extracting high-frequency signals higher than a predetermined frequency and low-frequency signals lower than the predetermined frequency from an input image signal;
calculating a predetermined temporary weight value based on the luminance level of the input image signal;
determining high-frequency signals involved in a gamma correction of the extracted high-frequency signals based on the calculated temporary weight value; and
applying the gamma correction to the extracted high-frequency signals and low-frequency signals involved in the gamma correction.

11. The gamma correction method as claimed in claim 10, wherein the temporary weight value calculation operation calculates a temporary weight value to reduce a ratio of the extracted high-frequency signals involved in the gamma correction as the luminance level of the input image signal becomes lower.

12. The gamma correction method as claimed in claim 11, wherein the temporary weight value calculation operation calculates the temporary weight value inversely proportional to the luminance level of the input image signal.

13. The gamma correction method as claimed in claim 12, wherein the temporary weight value calculation operation calculates the temporary weight value based the following:
$$\begin{matrix}\begin{matrix}k = - a \cdot {V}_{lum} + 1 , & ( 0 \leq {V}_{lum} \leq \frac{1}{a} )\end{matrix} \\ \begin{matrix}k = 0 , & ( {V}_{lum} > \frac{1}{a} ) ;\end{matrix}\end{matrix}$$
wherein k indicates the temporary weight value, −a indicates a slope of the temporary weight value, a indicates an absolute value of the slope, and Vₗᵤₘ indicates the luminance level of the input image signal.

14. The gamma correction method as claimed in claim 13, further comprising a slope calculation operation to calculate the absolute value of the slope based on an average luminance value of frames including the input image signal before the temporary weight value calculation operation,
wherein the frames or the fields become brighter as the absolute value of the slope becomes smaller.

15. The gamma correction method as claimed in claim 12, wherein the determination operation comprises operations of:
subtracting the temporary weight value smaller than ‘1’ from ‘1’ to calculate a final weight value to be applied to the extracted high-frequency signals; and
multiplying the final weight value and the extracted high-frequency signals to calculate high-frequency signals involved in the gamma correction.

16. The gamma correction method as claimed in claim 10, wherein the signal extraction operation comprises operations of:
extracting the low-frequency signals from the input image signal;
delaying the input image signal by a phase of the extracted low-frequency signals; and
subtracting the extracted low-frequency signals from the delayed input image signal to extract the high-frequency signals.

17. The gamma correction method as claimed in claim 10, further comprising an operation of adding the high-frequency signals and low-frequency signal to which the gamma correction has been applied to calculate a finally compensated image signal.

18. The gamma correction method as claimed in claim 17, further comprising an operation of multiplying the temporary weight value and the extracted high-frequency signals to calculate edge components of the input image signal, wherein the addition operation adds the compensated input image signal and the edge components to output the final image signal of which edge components have been compensated.

19. A gamma correction apparatus capable of preventing noise boost-up, comprising:
a signal extraction unit to extract high-frequency signals higher than a predetermined frequency and low-frequency signals lower than the predetermined frequency from an input image signal;
a final weight value calculation unit to calculate final weight values involved in gamma correction based on the luminance level of the input signal; and
a gamma correction unit to apply the gamma correction to the extracted high-frequency signals and low-frequency signals involved in the gamma correction.

20. The gamma correction apparatus as claimed in claim 19, wherein the final weight value calculation unit calculates the final weight values involved in the gamma correction based on the following equation:
$$\begin{matrix}\begin{matrix}{w}^{′} = {a}^{′} \cdot {V}_{lum} , & ( 0 \leq {V}_{lum} \leq \frac{1}{{a}^{′}} )\end{matrix} \\ \begin{matrix}{w}^{′} = 1 , & ( {V}_{lum} > \frac{1}{{a}^{′}} )\end{matrix}\end{matrix}$$
wherein, w′ has a final weight value of high-frequency signals involved in the gamma correction, a′ is a positive value as a slope of the final weight value, and Vₗᵤₘ is a luminance level of the input image signal Vᵢₙ normalized to ‘1’.

21. The gamma correction apparatus as claimed in claim 20, further comprising a slope calculation unit to calculate the absolute value of the slope based on the brightness of frames or fields including the input image signal,
wherein the frames or the fields becomes brighter as the absolute value of the slope becomes smaller.

22. The gamma correction apparatus as claimed in claim 19, wherein the signal extraction unit comprises:
a low-pass filter to extract the low-frequency signals from the input image signal;
a delay unit to delay the input image signal by a phase of the extracted low-frequency signals; and
a subtracter to subtract the extracted low-frequency signals from the delayed input image signal to extract the high-frequency signals.

23. The gamma correction apparatus as claimed in claim 19, further comprising an adder to add the high-frequency signals and low-frequency signal to which the gamma correction has been applied to calculate a finally compensated image signal.

24. The gamma correction apparatus as claimed in claim 23, further comprising a multiplier to multiply the final weight value and the high-frequency signal extracted by the subtracter to calculate the high-frequency signals involved in the gamma correction.

25. The gamma correction apparatus as claimed in claim 23, further comprising a subtracter to subtract from ‘1’ the final weight value w′ smaller that ‘1’ to calculate a temporary weight value to be given to the high-frequency signals, and a multiplier to multiply the temporary weight value and high-frequency signals output from the subtracter to calculate the high-frequency signals not involved in the gamma correction.

26. A computer readable storage medium containing a method capable of preventing noise boost-up, the method comprising operations of:
extracting high-frequency signals higher than a predetermined frequency and low-frequency signals lower than the predetermined frequency from an input image signal;
calculating a predetermined temporary weight value based on the luminance level of the input image signal;
determining high-frequency signals involved in a gamma correction of the extracted high-frequency signals based on the calculated temporary weight value; and
applying the gamma correction to the extracted high-frequency signals and low-frequency signals involved in the gamma correction.

27. The computer readable storage medium as claimed in claim 26, wherein the temporary weight value calculation operation calculates a temporary weight value to reduce a ratio of the extracted high-frequency signals involved in the gamma correction as the luminance level of the input image signal becomes lower.

28. The computer readable storage medium as claimed in claim 27, wherein the temporary weight value calculation operation calculates the temporary weight value inversely proportional to the luminance level of the input image signal.

29. The computer readable storage medium as claimed in claim 28, wherein the temporary weight value calculation operation calculates the temporary weight value based the following:
$$\begin{matrix}\begin{matrix}k = - a \cdot {V}_{lum} + 1 , & ( 0 \leq {V}_{lum} \leq \frac{1}{a} )\end{matrix} \\ \begin{matrix}k = 0 , & ( {V}_{lum} > \frac{1}{a} ) ;\end{matrix}\end{matrix}$$
wherein k indicates the temporary weight value, −a indicates a slope of the temporary weight value, a indicates an absolute value of the slope, and Vₗᵤₘ indicates the luminance level of the input image signal.

30. The computer readable storage medium as claimed in claim 29, further comprising a slope calculation operation to calculate the absolute value of the slope based on an average luminance value of frames including the input image signal before the temporary weight value calculation operation,
wherein the frames or the fields become brighter as the absolute value of the slope becomes smaller.

31. The gamma correction method as claimed in claim 28, wherein the determination operation comprises operations of:
subtracting the temporary weight value smaller than ‘1’ from ‘1’ to calculate a final weight value to be applied to the extracted high-frequency signals; and
multiplying the final weight value and the extracted high-frequency signals to calculate high-frequency signals involved in the gamma correction.

32. The gamma correction method as claimed in claim 26, wherein the signal extraction operation comprises operations of:
extracting the low-frequency signals from the input image signal;
delaying the input image signal by a phase of the extracted low-frequency signals; and
subtracting the extracted low-frequency signals from the delayed input image signal to extract the high-frequency signals.

33. The gamma correction method as claimed in claim 26, further comprising an operation of adding the high-frequency signals and low-frequency signal to which the gamma correction has been applied to calculate a finally compensated image signal.

34. The gamma correction method as claimed in claim 33, further comprising an operation of multiplying the temporary weight value and the extracted high-frequency signals to calculate edge components of the input image signal, wherein the addition operation adds the compensated input image signal and the edge components to output the final image signal of which edge components have been compensated.
